(19) United States
(12) Patent Application Publication
(10) Pub. No.: US 2010/0141531 A1
(43) Pub. Date: Jun. 10, 2010

(54) POSITION TRACKING APPARATUS AND METHOD FOR A LOW POWER WPAN/WBAN DEVICE

(76) Inventors: Hong Soon Nam, Daejeon (KR); Cheolhyo Lee, Daejeon (KR); Mi Kyung Oh, Daejeon (KR); Jae Young Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/542,091

(22) Filed: Aug. 17, 2009

(30) Foreign Application Priority Data
Dec. 8, 2008 (KR) 10-2008-0124216
Mar. 30, 2009 (KR) 10-2009-0027098

(51) Int. Cl. G01S 3/02

(52) U.S. Cl. 342/451

(57) ABSTRACT

Provided is a position tracking apparatus and method for low power WPAN/WBAN sensors in a sensor network. A position tracking apparatus collects distance information of adjacent nodes from a plurality of anchor nodes whose positions are known and at least one sensor node whose position is not known, in a sensor network, calculates the shortest path for the anchor node based on the collected distance information of the adjacent node, and classifies nodes into nodes of a first group whose positions are known and nodes of a second group whose positions are not known to select sensor nodes in an adjacent order from the second group to the first group based on the anchor node and detect the positions thereof.

### CROSS-REFERENCE TO RELATED APPLICATION

This application claims priority to and the benefit of Korean Patent Application No. 10-2008-0124216 filed in the Korean Intellectual Property Office on Dec. 08, 2008, and Korean Patent Application No. 10-2009-0027098 filed in the Korean Intellectual Property Office on Mar. 30, 2009, the entire contents of which are incorporated herein by reference.

### BACKGROUND OF THE INVENTION

(a) Field of the Invention

The present invention relates to a position tracking apparatus. More particularly, the present invention relates to a position tracking apparatus and method that are capable of easily tracking positions of sensor nodes in a network having a small number of anchor nodes.

(b) Description of the Related Art

A Wireless Personal Area Network (hereinafter abbreviated as “WPAN”)/Wireless Body Area Network (hereinafter abbreviated as “WBAN”) is a kind of wireless sensor network that is configured with low power, low cost, and small devices. A WPAN/WBAN sensor is an apparatus having low power and a relatively short communication distance and that can perform communication in a hop-to-hop manner that transmits its adjacent nodes when transmitting information of a sensor node to other nodes and transmits it from the adjacent nodes to its adjacent nodes.

In such a sensor network, as a position tracking method for the sensor nodes, there are a distance measuring method and an angle measuring method for two nodes. The distance measuring method may include a received signal strength indication (hereinafter abbreviated as “RSSI”) measuring method, a time of arrival (hereinafter abbreviated as “TOA”) measuring method (for example U.S. Patent Laid-Open Publication 2004-0235499, Ranging and Positioning System, Ranging and Positioning Method, and Radio Communication Apparatus), etc.

The position calculation of the sensor node is performed by calculating the position of the sensor by triangulation using distance information between any sensor node whose position will be tracked and the anchor node. Since many network topology changes, such as movement of the sensor nodes or the addition of new sensor nodes, occur in the sensor network, a sufficient number of anchor nodes should be previously disposed. However, the disposition of the anchor nodes is often inefficient. In this case, the sensor node and the anchor node do not directly communicate (1 hop) with each other and should communicate in multiple hops.

In other words, the distance between the anchor node and any sensor node cannot be directly measured, such that it should be measured in the multiple hops.

However, since the distance measured in the multiple hops has a large difference according to a spatial arrangement between the anchor node and the sensor node, when the position is estimated by triangulation using this distance, there is a problem in that significant position error occurs.

Meanwhile, in order to improve the problem, a method using multidimensional scaling (MDS) (for example U.S. Patent Laid-Open Publication 2005-0080924 A1, Node Localization in Communication Networks), etc., is disclosed. However, since this method has time complexity of O(n³), there is a problem in that the method requires much time and effort to determine the position.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a position tracking system and method having advantages of rapidly and accurately tracking positions of sensor nodes by calculating the positions with low calculation complexity in order for a sensor to recognize the positions of the sensor nodes.

In order to solve the above technical problems, an exemplary embodiment of the present invention provides a position tracking apparatus for low output WPAN/WBAN sensors, including:

a measured distance collector that collects distance information of adjacent nodes from a plurality of anchor nodes whose positions are known by being fixed and at least one sensor node whose positions are not known, respectively, in a sensor network; a shortest distance calculator that calculates each of the shortest paths to the anchor nodes based on the distance information of the collected adjacent nodes and selects and manages a sensor node having the shortest path and shortest distance for the anchor node as a parent node; a group separator that separates a first group whose positions are known and a second group whose positions are not known according to whether the positions of each node are known, the anchor node being included in the first group; and a controller that selects a first sensor node nearest to the nodes of the first group from the second group to find its parent node and that corrects the distance information (measuring value) of the shortest path for the anchor node of the first sensor node by reflecting the estimated position of the parent node of the first sensor node and the distance information of the shortest path for the anchor node of the parent node, the controller detecting the position of the first sensor node based on the corrected shortest path.

Further, another exemplary embodiment of the present invention provides a position tracking method for low output WPAN/WBAN sensors by a position tracking apparatus in a sensor network, including:

a) collecting distance information of adjacent nodes from a plurality of anchor nodes whose positions are known and at least one sensor node whose positions are not known, respectively; b) calculating each of shortest paths to the anchor nodes based on the distance information of the collected adjacent nodes and selecting and managing the sensor node having the shortest path and shortest distance for the anchor node as a parent node; c) separating a first group whose positions are known and a second group whose positions are not known according to whether the positions of each node are detected, the anchor node being included in the first group; d) selecting a first sensor node adjacent to the nodes of the first group from the second group to find its parent node and correcting the distance information (measuring value) of the shortest path for the anchor node of the first sensor nodes by reflecting the estimated position of the parent node of the first sensor node and the distance information of the shortest path for the anchor node of the parent node; and e) detecting the position of the first sensor node based on the corrected distance information of the shortest path.

### BRIEF DESCRIPTION OF THE DRAWINGS

FIG. 1 is a network configuration diagram schematically showing a position tracking apparatus that is capable of tracking positions of sensors according to an exemplary embodiment of the present invention;

FIG. 2 is an exemplary diagram showing triangulation for determining the positions of the sensor nodes according to an exemplary embodiment of the present invention;

FIG. 3 is a flowchart showing a position estimating method for the sensor nodes according to an exemplary embodiment of the present invention;

FIG. 4 is a flowchart showing a method for finding adjacent nodes between two groups according to an exemplary embodiment of the present invention;

FIG. 5 is a flowchart showing a position correction method for a sensor node u according to an exemplary embodiment of the present invention;

FIG. 6 is a diagram showing a process of changing Gᵤₖ group into Gₖ group according to an exemplary embodiment of the present invention; and

FIG. 7 is a graph showing a simulation result showing a position tracking error according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a position tracking apparatus and method for a low output WPAN/WBAN sensor will be described in detail with reference to the drawings.

In the following description, the specific details of the position tracking apparatus and method are disclosed to provide an overall understanding of the present invention. However, it is apparent to those skilled in the art that the present invention can be easily practiced without describing the specific details and modification thereof.

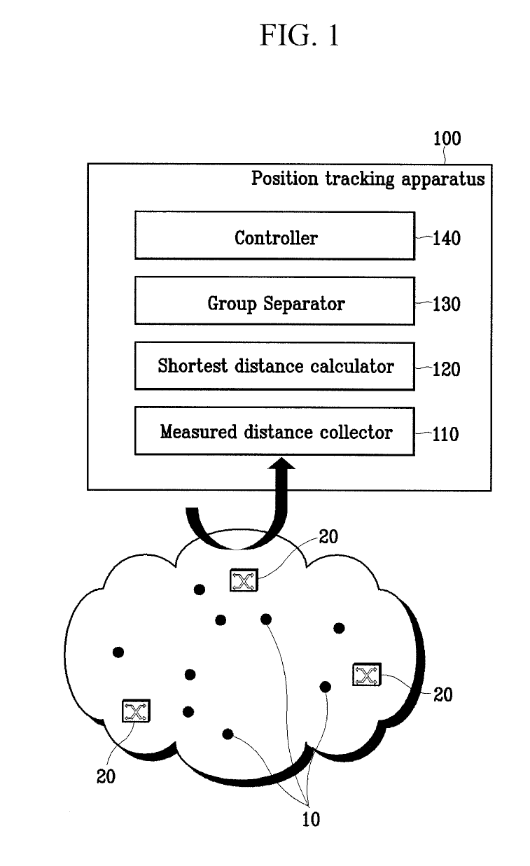

FIG. 1 is a network configuration diagram schematically showing a position tracking apparatus that is capable of tracking positions of sensors according to an exemplary embodiment of the present invention.

Referring to FIG. 1, the position tracking apparatus according to an exemplary embodiment of the present invention includes at least three anchor nodes 10, a plurality of sensor nodes 20, and a position tracking apparatus 100 in the case of a two-dimensional plane in order to estimate the position by a system for detecting the position information of the sensors in a sensor network. Further, the position tracking apparatus is not limited thereto, and in the case of a three-dimensional space, may include at least four anchor nodes 10.

Each anchor node 10, which is a fixed node whose position is known, is a reference point when calculating the position of the sensor node 20. The position of the anchor node 10 may be set by using a global positioning system (GPS), or artificially. After the anchor node 10 is disposed, its position is set and can then perform a function as the anchor node 10. Generally, the anchor node 10 preferably has a structure in which there is little limitation in view of use of energy.

The sensor node 20 transmits information sensed in various environments or physical systems or a specific event associated with the sensor based on a wireless communication technology, and is a wireless node that is configured of a sensor, a processor, and communication devices.

The plurality of anchor nodes 10 may exist in one network, and the sensor node 20 may exist at a fixed position as an anchor node or has mobility. Since the anchor node 10 generally has limited usable energy, it should be operated at a low power, and is linked with the anchor node 10 and the adjacent sensor nodes 20 to communicate with each other in a hop-to-hop manner.

The sensor node 20 and the anchor node 10 each measures a distance of an adjacent node and perform a role of transmitting the measured distance to the position tracking apparatus 100.

The position tracking apparatus 100 has a function of managing surrounding position information, the position information of an anchor node 10, and the distance information between the anchor node 10 and an adjacent sensor node 20 and another sensor node 20 and other sensor nodes 10, and periodically or non-periodically tracks the position of the sensor node 20.

To this end, the position tracking apparatus 100 includes a measured distance collector 110, a shortest distance calculator 120, a group separator 130, and a controller 140.

The measured distance collector 110 performs a role of collecting the measured distance information between the adjacent nodes from the anchor node 10 and the sensor node 20, respectively.

The shortest distance calculator 120 finds the shortest path from each sensor node 20 to the anchor node 10, and calculates the distance of the shortest path based on the collected distance information between the adjacent nodes. At this time, the shortest distance calculator 120 manages the shortest path nearest to the anchor node 10 and the adjacent node having the shortest path as a “parent node”.

The group separator 130 performs a role of separating a group (hereinafter, “Gᵤ”) whose positions are known and a group (hereinafter, “Gₖ”) whose positions are not known, among the plurality of sensor nodes 20. In other words, the Gᵤ group means a group of sensor nodes whose positions are detected and the Gₖ group means a group of sensor nodes whose positions are not detected.

The controller 140 selects one sensor node 20 that is nearest to the Gᵤ group from the Gₖ group, and corrects the distance of the shortest path for the anchor node 10 of the selected sensor node 20 by reflecting the estimated position of the parent node of the corresponding sensor node 20 and the shortest path distance for the anchor node 10 of the parent node. Further, the controller 140 calculates the position of the sensor node 20 by applying the collected distance to triangulation.

The controller 140 repeatedly performs the processes of correcting the shortest distance and calculating the position until the positions of all the sensor nodes of the Gᵤ group are estimated.

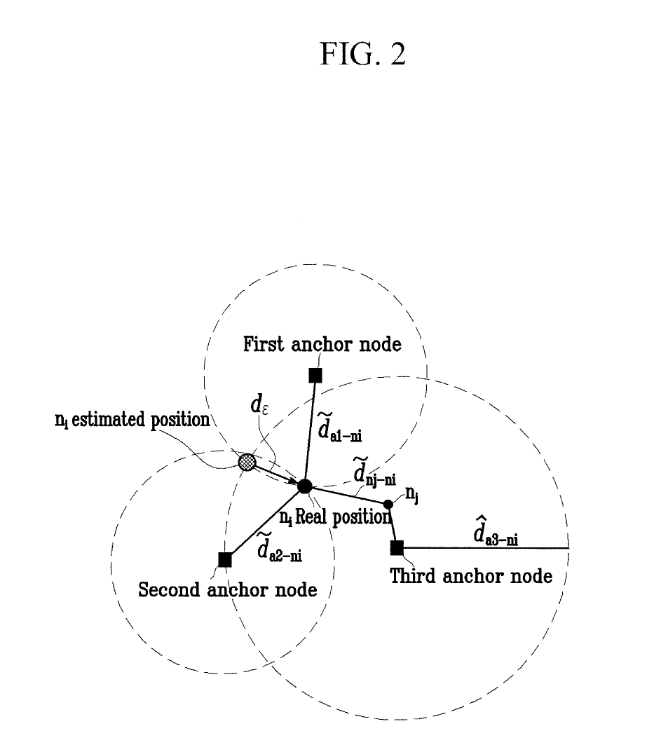

FIG. 2 is an exemplary diagram showing triangulation for determining the positions of the sensor nodes according to an exemplary embodiment of the present invention.

Referring to FIG. 2, the sensor network according to an exemplary embodiment of the present invention includes three anchor nodes (first, second, and third anchor nodes) and two sensor nodes (nᵢ and nⱼ). Herein, it is assumed that the sensor node nᵢ whose position will be determined is in a direct communication distance with the first anchor node and the second anchor node and is connected with the third anchor node in two hops via nⱼ.

At this time, a distance dₐ₁₋ₙᵢ between the first anchor node and the sensor node nᵢ and a distance dₐ₂₋ₙᵢ between the second anchor node and the node nᵢ can be directly measured, and the measured distances are assumed to be \tilde{d}ₐ₁₋ₙᵢ and \tilde{d}₂ₐ₋ₙᵢ. The distance dₐ₃₋ₙᵢ between third anchor node and the nᵢ cannot be directly measured, but can be estimated by using the distance \tilde{d}ₐ₃₋ₙⱼ between the third anchor node and the sensor node nⱼ and the distance \tilde{d}ₙⱼ₋ₙᵢ between the sensor node nⱼ and the sensor node nᵢ. Also, the position of the sensor node nᵢ is calculated by the triangulation using the positions of the three anchor nodes and the three sets of distance information. Herein, a distance dₐ₃₋ₙᵢ between the third anchor node and the sensor node nᵢ is larger than dₐ₃₋ₙⱼ or dₙⱼ₋ₙᵢ defined by the following Equation 1, and is equal to or smaller than a sum of dₐ₃₋ₙⱼ and dₙⱼ₋ₙᵢ.

max {dₐ₃₋ₙⱼ, dₙⱼ₋ₙᵢ}<dₐ₃₋ₙᵢ≦dₐ₃₋ₙⱼ+dₙⱼ₋ₙᵢ [Equation 1]

The estimate \hat{d}ₐ₃₋ₙᵢ of dₐ₃₋ₙᵢ from Equation 1 is equal to or smaller than \tilde{d}ₐ₃₋ₙⱼ+\tilde{d}ₙⱼ₋ₙᵢ and the error of the estimated position of the sensor node nᵢ occurs according to the error of the estimate such that there is a need to accurately estimate the distance with the anchor node.

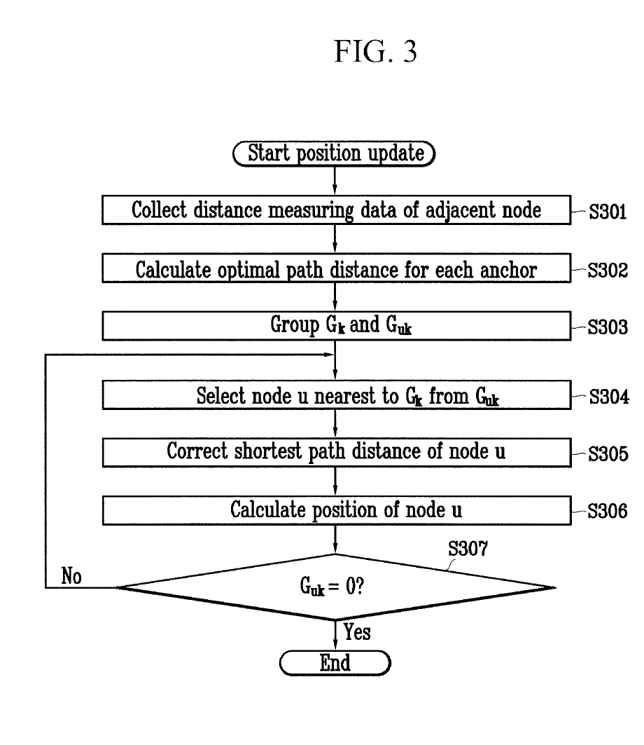

FIG. 3 is a flowchart showing a position estimating method for the sensor nodes according to an exemplary embodiment of the present invention.

Referring to FIG. 3, the position tracking apparatus 100 according to an exemplary embodiment of the present invention first collects distance measuring data of the adjacent nodes measured in each sensor node 20 in order to periodically or non-periodically estimate the positions of each of the sensor nodes 20 (S301). The distance can be calculated by measuring TOA between two nodes and considering propagation speed.

The position tracking apparatus 100 calculates the shortest path and the shortest path distance for each anchor node 10 from the collected distance information between the adjacent nodes (S302). Herein, the shortest path distance is calculated by a sum of the distance between two nodes along the shortest path from the sensor node 20 to the anchor node 10.

The position tracking apparatus 100 separates the sensor nodes 20 into the Gₖ group whose positions are detected and the Gᵤₖ group whose positions are not detected, and groups them (S303). At an initial step, the anchor node 10 is included in the Gₖ group and the sensor node 20 is included in the Gᵤₖ group. The position tracking apparatus 100 classifies the groups into detailed groups based on the anchor node 10 when classifying the groups, and calculates the positions in a classified detailed group unit, making it possible to reduce the calculation complexity. Each detailed group should include at least three anchor nodes and two sensor nodes in a two-dimensional plane as shown in FIG. 1.

Next, the position tracking apparatus 100 selects the nearest (adjacent) sensor node u between the Gₖ group and the Gᵤₖ group, and finds the parent node p corresponding to the sensor node u (S304).

Also, the position tracking apparatus 100 corrects the distance measuring value of the shortest path for the anchor node 10 of the sensor node u by considering the estimated position of the parent node p and the distance measuring value of the shortest path for the anchor node 10 of p (S305).

Then, the position tracking apparatus 100 estimates the position of the sensor node u by using the triangulation from the corrected distance information and the position information of the anchor node 10 (S306).

The position tracking apparatus 100 confirms whether there is the sensor node 20 whose position should be tracked in the Gᵤₖ group. If not (S307, Yes), the process ends and if so (S307, No), steps 304 to 307 are repeated.

In other words, the position tracking apparatus 100 repeatedly performs a process of finding the nearest node in the Gₖ group to correct the shortest path distance and calculate the position until the Gᵤₖ group is 0 in order to estimate the positions of all the sensor nodes 20.

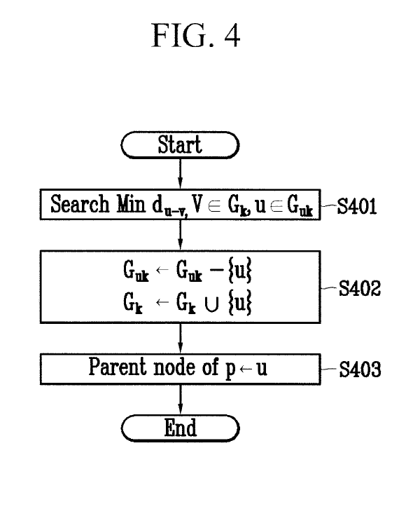

Meanwhile, a method for finding the nearest node between two groups Gₖ and Gᵤₖ according to an exemplary embodiment of the present invention will be described with reference to FIG. 4.

FIG. 4 is a flowchart showing a method for finding adjacent nodes between two groups according to an exemplary embodiment of the present invention.

Referring to FIG. 4, the position tracking apparatus 100 according to an exemplary embodiment of the present invention confirms whether the adjacent node nⱼ of any sensor node nᵢ of the Gᵤₖ group belongs to the Gₖ group, and if so, finds the sensor node whose dₙᵢ₋ₙⱼ is minimum, and this sensor node is referred to as a node u (S401).

In other words, the sensor node u is cancelled in the Gᵤₖ group and is included in the Gₖ group (S402).

The parent node of the sensor node u can be appreciated from the shortest path calculated at step S302 of FIG. 3, and the parent node is referred to as p (S403).

As such, the shortest path calculation for one anchor can use a verified method, such as a shortest path (Dijkstra) algorithm, etc. If V is the number of nodes and E is the number of adjacent nodes in any graph G=(V, E), the shortest path calculation for one anchor has the complexity of O(ElgV)

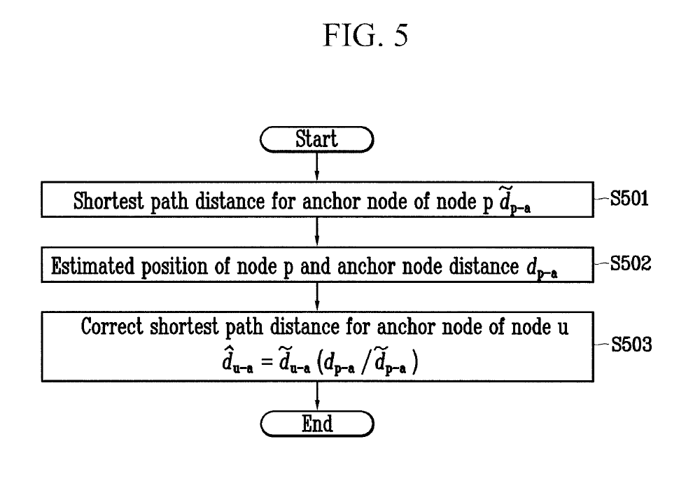

FIG. 5 is a flowchart showing a position correction method for the sensor node u according to an exemplary embodiment of the present invention.

Referring to FIG. 5, a process of correcting the shortest distance for the anchor of the sensor node u according to an exemplary embodiment of the present invention from the position of its parent node p and the shortest distance information is shown.

The position tracking apparatus 100 calculates the distances dₚ₋ₐ₁, dₚ₋ₐ₂, and dₚ₋ₐ₃, respectively, between the estimated position of the node p and the anchor node 10 from the position of the parent node estimated in FIG. 4 (S501 and S502). Correcting the measured distances \tilde{d}ᵤ₋ₐ₁, \tilde{d}ᵤ₋ₐ₂, and \tilde{d}ᵤ₋ₐ₃ for the shortest path of the node u from the measured distances \tilde{d}ₚ₋ₐ₁, \tilde{d}ₚ₋ₐ₂ and \tilde{d}ₚ₋ₐ₃ of the shortest path for the anchor node 10 by considering the position of the parent node p is defined in the following Equation 2.

\hat{d}ᵤ₋ₐ₁=\tilde{d}ᵤ₋ₐ₁(dₚ₋ₐ₁/\tilde{d}ₚ₋ₐ₁)

\hat{d}ᵤ₋ₐ₂=\tilde{d}ᵤ₋ₐ₂(dₚ₋ₐ₂/\tilde{d}ₚ₋ₐ₂)

\hat{d}ᵤ₋ₐ₃=\tilde{d}ᵤ₋ₐ₃(dₚ₋ₐ₃/\tilde{d}ₚ₋ₐ₃) [Equation 2]

In other words, the position tracking apparatus 100 can correct the shortest path distance for the anchor node 10 of the sensor node u as defined by Equation 2 by considering the distance calculating value between the estimated position of the parent node p and the anchor node 10 and the distance measuring value of the shortest path for the corresponding node (S503).

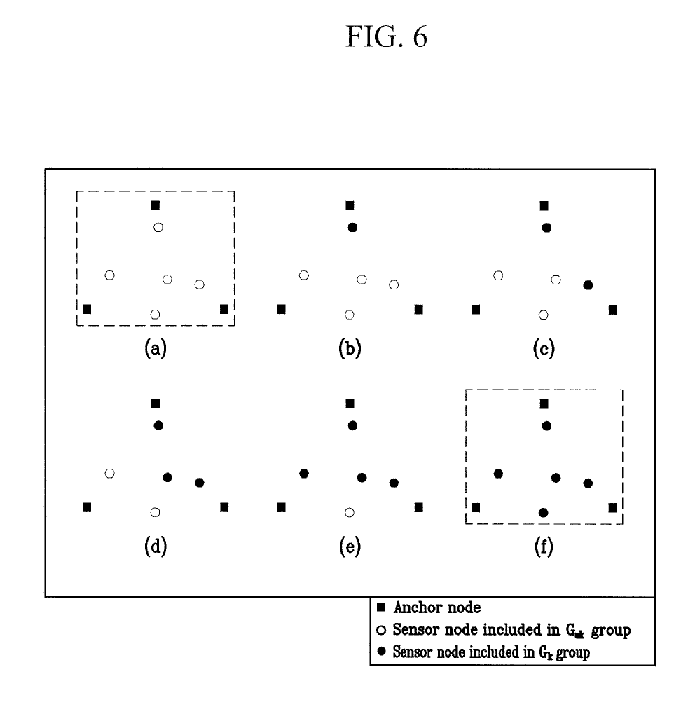

FIG. 6 is a diagram showing a process of changing the Gᵤₖ group into the Gₖ group according to an exemplary embodiment of the present invention.

FIG. 6 shows that the sensor nodes 20 are changed from the Gᵤₖ group to the Gₖ group by detecting the positions of the sensor nodes 20 in the sensor network by the position tracking apparatus 100 according to an exemplary embodiment of the present invention.

It is assumed that the sensor network according to the exemplary embodiment of the present invention includes three anchor nodes 10 and five sensor nodes 20.

First, (a) of FIG. 6, which is an initial state, shows a case where the Gₖ group represented by a quadrangle(▪) includes the anchor node and the Gᵤₖ group represented by a circle (◯) includes the plurality of sensor nodes. (b) shows a case where the sensor node () nearest to the anchor node (▪) included in the Gₖ group among the nodes belonging to the Gᵤₖ group is included in the Gₖ group. And (c) to (f) show a case where all the sensor nodes 20 are included in the Gₖ group by including the sensor nodes one by one from the Gᵤₖ group to the Gₖ group as in (b). This means that the position tracking apparatus 100 according to the exemplary embodiment of the present invention calculates the positions of all the sensor nodes 20.

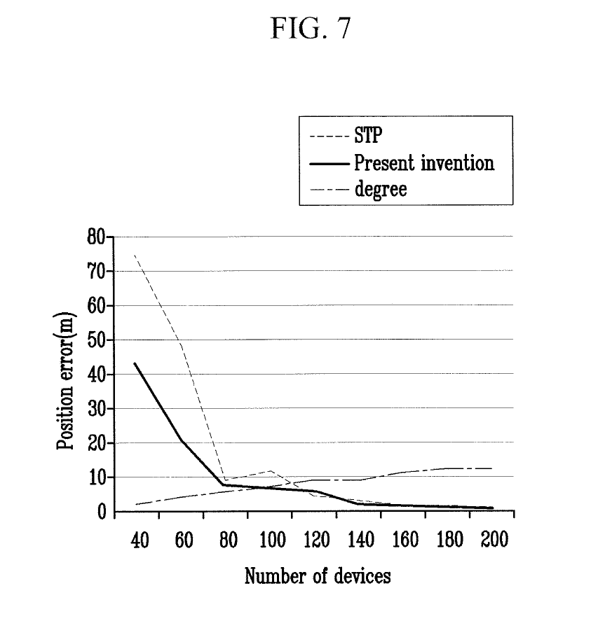

Meanwhile, FIG. 7 is a graph showing a simulation result showing a position tracking error according to an exemplary embodiment of the present invention.

Referring to FIG. 7, the results of simulating the position error estimated without correcting the shortest path distance to the anchor node 10 and the position error estimated by correcting the shortest path distance by using MATLAB are shown in a graph.

It is assumed that the simulation environment has a 100 m×100 m plane and has the anchor nodes 10 each disposed at four edges [(0 and 0), (100,0), (0,100), and (100 and 100)]. The sensor nodes 20 are randomly disposed on the plane but are experimented by being changed by 20 from 40 to 200. Further, it is assumed that the communication distance (coverage) between the anchor node 10 and the anchor node 10 is 30 m or less.

The simulation results show that when the number of sensor nodes 20 is 40 the minimum number of adjacent nodes is 4, in the case of an STP method of estimating the positions without correcting the shortest path distance the position estimating error is 74 m, and in the case of estimating the position by correcting the distance like the present invention the position estimating error is 43 m. Further, it is shown that when the number of sensor nodes 20 is 200, in the case of the STP method, the position estimating error is 1.4 m, and in the case of the present invention, the position estimating error is 1.1 m. As a result, it can be appreciated that when the devices (sensor nodes) are densely distributed, both methods can more accurately estimate the positions.

As such, with the exemplary embodiment of the present invention, in the sensor network where the sensor nodes are randomly distributed densely, the positions of the sensor are simply calculated by a few anchor nodes, making it possible to easily track the positions of the sensor nodes.

Particularly, the positions are calculated by obtaining the shortest paths for each anchor node and sequentially adding the sensor nodes one by one from the sensor node nearest to each anchor node, making it possible to reduce the complexity and to rapidly and accurately track the positions of the sensor nodes 20 using the distance information between the sensors even in a space having few anchor nodes 10.

Although the exemplary embodiments of the present invention were described, the present invention is not limited to the exemplary embodiments and can be variously modified.

Although the exemplary embodiment of the present invention shown in FIG. 1 described the two-dimensional plane including at least three anchor nodes and two sensor nodes by way of example, the present invention is not limited thereto. For example, the present invention can further include at least one anchor node 10. Therefore, the present invention can easily track the position of the sensor node 20 in a three-dimensional space such as inside a building.

Further, with an exemplary embodiment of the present invention, the sensors may be disposed in a room enveloped by flames, making it possible to detect a position of a fire fighter, or may be temporarily disposed in an airport, a department, etc., making it possible to detect dangerous materials or contaminants. Further, the sensor nodes 20 may be disposed at an area where the anchor nodes 10 are difficult to dispose, for example on mountains, making it possible to detect the position of victims, and may be disposed in a human body, making it possible to detect a position of a low power implant, etc.

By the above configuration, with the exemplary embodiment of the present invention, in the sensor network where the sensor nodes are randomly distributed densely, the positions of the sensor nodes are calculated with low calculation complexity by a few anchor nodes, making it possible to rapidly and accurately track the positions of the sensor nodes at a low power.

As such, with the exemplary embodiment of the present invention, in the sensor where the sensor nodes are randomly distributed densely, the positions of the sensor are simply calculated by a few anchor nodes, making it possible to easily track the positions of the sensor nodes.

Particularly, the positions are calculated by obtaining the shortest paths for each anchor node and sequentially adding one by one from the sensor node nearest to each anchor node, making it possible to reduce the complexity and to rapidly and accurately track the positions of the sensor nodes at a low power.

Further, with an exemplary embodiment of the present invention, the sensors may be disposed in a room enveloped by flames, making it possible to detect a position of a fire fighter, or may be temporarily disposed in an airport, a department, etc., making it possible to detect dangerous materials or contaminants. It is possible to detect a position of an object in an area where nodes are difficult to dispose, for example on mountains, and to detect a position of a low power implant, etc. disposed in a human body, according to the method of the exemplary embodiments of the present invention.

The exemplary embodiments of the present invention as described above are implemented not only by the method and apparatus, but also by programs that achieve functions corresponding to the configuration of the exemplary embodiments of the present invention or recording mediums including the programs. This can be easily implemented from the foregoing exemplary embodiments by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A position tracking apparatus, comprising:
a measured distance collector that collects distance information of adjacent nodes from a plurality of anchor nodes whose positions are known by being fixed and at least one sensor node whose positions are not known, respectively, in a sensor network;
a shortest distance calculator that calculates each of the shortest paths to the anchor nodes based on the distance information of the collected adjacent nodes and selects and manages a sensor node having the shortest path and shortest distance for the anchor node as a parent node;
a group separator that separates nodes in the sensor network into a first group whose positions are known and a second group whose positions are not known according to whether the positions of each node are known, the anchor node being included in the first group; and
a controller that selects a first sensor node nearest to the nodes of the first group from the second group to find its parent node and that corrects the distance information (measuring value) of the shortest path for the anchor node of the first sensor node by reflecting the estimated position of the parent node of the first sensor node and the distance information of the shortest path for the anchor node of the parent node,
the controller detecting the position of the first sensor node based on the distance information of the corrected shortest path.

2. The position tracking apparatus of claim 1, wherein
the controller
detects the positions by calculating the position of the n-th sensor node of the second group based on the corrected distance information.

3. The position tracking apparatus of claim 1, wherein
the controller,
when the position of the first sensor node is detected, removes the first sensor node from the second group and includes it in the first group.

4. The position tracking apparatus of claim 2, wherein
the shortest distance calculator
calculates the distance information of the shortest path by a sum of distances between nodes disposed on the shortest path from the sensor node to the anchor node.

5. The position tracking apparatus of claim 2, wherein
the group separator
classifies the first group and the second group into detailed groups based on each of the anchor nodes, and
the controller independently calculates positions of sensor nodes in the detailed group unit.

6. The position tracking apparatus of claim 5, wherein
the shortest path calculation for one anchor node has complexity of O(ElgV) where V means the number of nodes and E means the number of adjacent nodes.

7. A position tracking method for sensor nodes by a position tracking apparatus in a sensor network, comprising:
collecting distance information of adjacent nodes from a plurality of anchor nodes whose positions are known and at least one sensor node whose position is not known, respectively;
calculating each of shortest paths to the anchor nodes based on the distance information of the collected adjacent nodes and selecting and managing the sensor node having the shortest path and shortest distance for the anchor node as a parent node;
separating a first group whose positions are known and a second group whose positions are not known according to whether the positions of each node are detected, the anchor node being included in the first group;
selecting a first sensor node adjacent to the nodes of the first group from the second group to find its parent node and correcting the distance information (measuring value) of the shortest path for the anchor node of the first sensor nodes by reflecting the estimated position of the parent node of the first sensor node and the distance information of the shortest path for the anchor node of the parent node; and
detecting the position of the first sensor node based on the corrected distance information of the shortest path.

8. The position tracking method of claim 7, further comprising,
after the detecting the position of the first sensor node step,
detecting the positions by calculating the position of the n-th sensor node of the second group based on the corrected distance information.

9. The position tracking method of claim 7, wherein, the separating further
the first group and the second group are separated into at least three detailed groups which are respectively formed based on an anchor node in the case of tracking positions of sensor nodes in a two-dimensional plane, or
the first group and the second group are separated into at least four detailed groups which are respectively formed based on an anchor node in the case of tracking positions of sensor nodes in a three-dimensional plane.

10. The position tracking method of claim 9, wherein the detecting the position of the first sensor node, when the position of the first sensor node is detected, removes the first sensor node from the second group and includes it in the first group.
